(19) United States
(12) Patent Application Publication
(10) Pub. No.: US 2024/0066950 A1
(43) Pub. Date: Feb. 29, 2024

(54) MULTIDIRECTIONAL VENT FOR VEHICLE HVAC SYSTEM

(71) Applicant: APTERA MOTORS CORP., SAN DIEGO, CA (US)

(72) Inventors: Jason HILL, Costa Mesa, CA (US); John A. KLOPP, III, Encinitas, CA (US)

(73) Assignee: APTERA MOTORS CORP., SAN DIEGO, CA (US)

(21) Appl. No.: 18/453,958

(22) Filed: Aug. 22, 2023

Related U.S. Application Data
(60) Provisional application No. 63/400,320, filed on Aug. 23, 2022.

(51) Int. Cl. B60H 1/00

(52) U.S. Cl. CPC B60H 1/00842; B60H 1/00028; B60H 2001/00214

(57) ABSTRACT

The present invention relates to an airside system for a vehicle HVAC system and to a HVAC apparatus, system and method having a multidirectional vent formed integrally with a mount adapted to receive a user interface in the form of a centrally disposed touch screen. The vent/interface assembly may be disposed inside the vehicle cabin including, but not limited to, the dashboard and/or instrument panel. The one or more outlets of the vent may be disposed partially or completely around the touch screen perimeter. Each outlet may flow in one or more directions, be individually adjustable either automatically or manually, or be stationary. The assembly may be configured to position the user interface offset from the dashboard. The outlet(s) of the vent may be partially or completely hidden behind the user interface. On/off and directional control of each outlet may be achieved by means of vanes, blades, and/or slots.

### CROSS-REFERENCE TO RELATED APPLICATION

This application claims priority to, and the benefit of, co-pending U.S. Provisional Patent Application No. 63/400,320, filed on Aug. 23, 2022, entitled “Multidirectional Vent For Vehicle HVAC System”, which is incorporated by reference in its entirety.

### TECHNICAL FIELD

The present invention relates to an airside system for a vehicle HVAC system and, in particular, to a HVAC apparatus, system and method having a multidirectional vent formed integrally with a manifold adapted to receive a centrally disposed touch screen.

### BACKGROUND

Modern vehicles increasingly employ display systems that may include touchscreen technology so as to provide most or all of the user control functions associated vehicle systems such as, for example, navigation, climate control, infotainment, and other systems. Such display systems are designed to have customer appeal using a sleek design devoid of the conventional multitude of cumbersome buttons and knobs that modern vehicles may employ. A touchscreen display can be connected by a support and not integrally formed with the dashboard. Use of display systems eliminates a design constraint of connecting buttons, knobs, sliders, and the like to the heating, ventilation, and air conditioning (HVAC) system controls when integrally formed with the dashboard. The HVAC system can be located remotely and dashboard vents can be connected via ducting, housings and other structures to provide airflow to the cabin or other passenger compartment. Regardless of the specific dashboard configuration, and whether a touchscreen or other interface is provided, the dashboard remains one feature that drives consumer perception of a vehicle and its manufacturer.

Conventional dashboard designs incorporating HVAC systems use vents and vanes provided in various locations on the dashboard, and other components embedded therein, to serve a variety of air treatment purposes. Problems generally associated with airside systems on a vehicle dashboard include limited space, difficulty in assembly and maintenance, coordination with other vehicle components, functionality of the vent system, and aesthetic appeal of the visible portions of the HVAC system in the context of the overall dashboard or other panel assembly. Moreover, conventional HVAC systems may represent added weight to the vehicle, which limits the range of the electric vehicle and its overall efficiency.

Concerning limited space, the free area (i.e., unobstructed portions) of the vents govern the volume of air flow able to be delivered to the cabin and is usually designed to provide a predetermined volumetric flow rate in units of cubic feet per minute or liters per second sufficient for the cabin. Free area also determines the flow velocity through any given vent configuration, and standardized rules regarding volumetric flow rates are used to develop the amount of air needed for a particular vehicle application. Further limitations on free area include incorporating other vehicle components of the airside systems that are operably connected and controlled using a central touchscreen. Electric vehicles that have in-cabin solar panels and additional components further limit the free area to incorporate HVAC systems in the overall dashboard or other panel assembly.

As to the functionality of the airside system, some vent system designs involve high aspect ratio vents, i.e., elongated, thin slots that may conform to features in, on, or around the dashboard. High aspect ratio vent configurations may be characterized in that the airflow may be subject to instability over the operable range of volumetric flow rates, and/or that traditional manual passenger control, such as directable vanes, may be more difficult to employ. Thus, unique challenges still exist to provide high aspect ratio vents in the available free area of a dashboard or other panel assembly.

Accordingly, what is needed is a multidirectional vent capable of overcoming the aforementioned problems in the art.

### SUMMARY

The present invention discloses a functionally, economically, and aesthetically advantageous vehicular HVAC system that employs a multidirectional vent system wherein at least a portion of a centrally-disposed user interface mount serves as an air channel.

A further object of the present invention is to provide a user interface mount having a multidirectional vent system coupled to further components defining an HVAC system, wherein the mount and user interface coupled thereto may be located within the dash, located proximate the dash, or spaced apart from the dash.

A further object of the present invention is to provide a vent system having a visually appealing and minimally obtrusive aesthetic, wherein the vent system may assume a high aspect ratio having one or more linear slot diffusers. Such high aspect ratio, linear slot diffusers may be optimized to provide stable, steady-state fluid flow over the operable range of the vent airflow volume.

A further object of the present invention is to provide a variety of flow direction options including, but not limited to upward, downward, left, right, and outward directions, which may be defined as originating from a centrally disposed position on the vehicle dashboard and projecting into a cabin interior accordingly. Such multi-vent, or multi-directional, functionality may incorporate controllable vent output direction, i.e., alterable direction of a vent of the one or more vents, which may be actively or passively controllable.

A further object of the present invention is to provide lighting disposed proximate one or more linear slot diffusers and which encompass the entire uninterrupted perimeter of the user interface.

Other desirable features and characteristics will become apparent from the subsequent detailed description, the drawings, and the appended claims, when considered in view of this summary.

### DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 illustrates a schematic diagram of an exemplary HVAC system layout, according to an embodiment of the present invention;

FIG. 2 illustrates a line diagram of portions of an HVAC system, including a multidirectional vent assembly, according to an embodiment of the present invention;

FIG. 3 illustrates a perspective view of a dashboard, including a multidirectional vent assembly, according to an embodiment of the present invention;

FIG. 4 illustrates a perspective view of a multidirectional vent assembly, according to an embodiment of the present invention;

FIG. 5A illustrates a cross-sectional view, taken along line 5A-5A of FIG. 4, of a multidirectional vent assembly, according to an embodiment of the present invention;

FIG. 5B illustrates a cross-sectional view, taken along line 5B-5B of FIG. 4, of a multidirectional vent assembly, according to an embodiment of the present invention;

FIG. 6 illustrates a perspective view of a vehicle cabin interior, including a dashboard and multidirectional vent assembly, according to an embodiment of the present invention;

FIG. 7 illustrates a perspective view of a multidirectional vent assembly including vanes, according to an alternative embodiment of the present invention;

FIG. 8A illustrates a rear perspective view, taken along line 8A of FIG. 7, of the multidirectional vent assembly with vanes thereof;

FIG. 8B illustrates a perspective view, taken along line 8B of FIG. 7, of the multidirectional vent assembly with vanes thereof;

FIG. 9A illustrates a section view, taken along line 9AB of FIG. 7, of the multidirectional vent assembly with a vane in a middle open position thereof;

FIG. 9B illustrates a section view, taken along line 9AB of FIG. 7, of the multidirectional vent assembly with a vane in a closed position thereof;

FIG. 10 illustrates a perspective view of a multidirectional vent assembly including blades, according to an alternative embodiment of the present invention;

FIG. 11A illustrates a perspective view, taken along line 11A of FIG. 10, of the multidirectional vent assembly with blades thereof;

FIG. 11B illustrates a perspective view, taken along line 11B of FIG. 10, of the multidirectional vent assembly with blades thereof;

FIG. 12A illustrates a section view, taken along line 12AB of FIG. 10, of the multidirectional vent assembly with a blade in a fully open position thereof;

FIG. 12B illustrates a section view, taken along line 12AB of FIG. 10, of the multidirectional vent assembly with a blade in a closed position thereof;

FIG. 13 illustrates a perspective view of a multidirectional vent assembly with slots, according to an alternative embodiment of the present invention;

FIG. 14A illustrates a perspective view, taken along line 14A of FIG. 13, of the multidirectional vent assembly with slots thereof;

FIG. 14B illustrates a perspective view, taken along line 14B of FIG. 13, of the multidirectional vent assembly with slots thereof;

FIG. 15A illustrates a section view, taken along line 15AB of FIG. 13, of the multidirectional vent assembly with a slot in a middle open position thereof; and

FIG. 15B illustrates a section view, taken along line 15AB of FIG. 13, of the multidirectional vent assembly with a slot in a closed position thereof.

### DETAILED DESCRIPTION

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. For a better understanding of the present invention, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

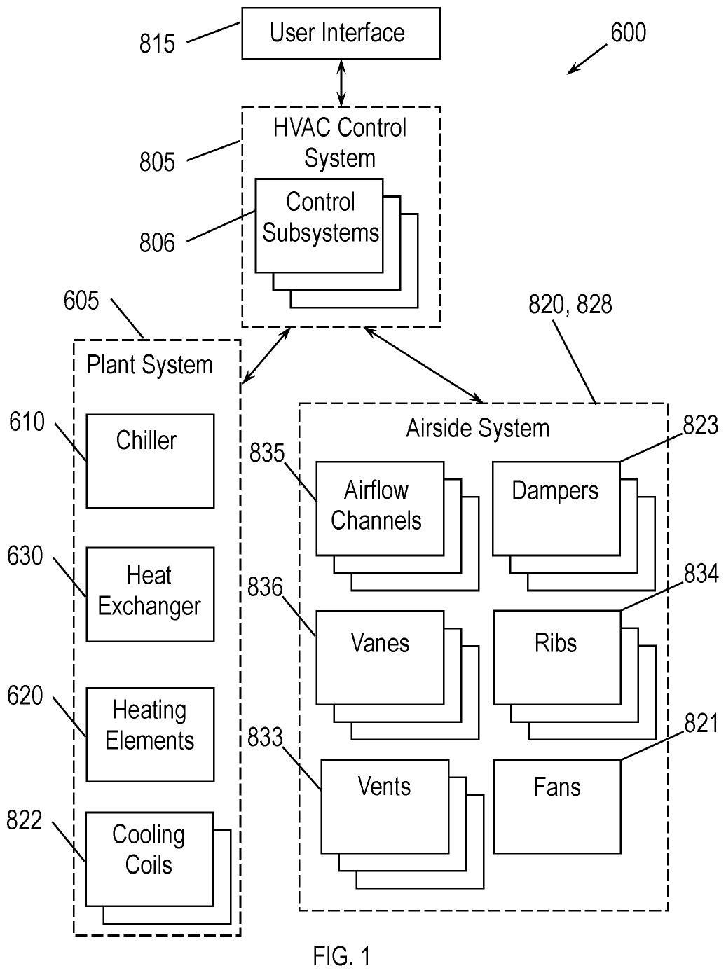

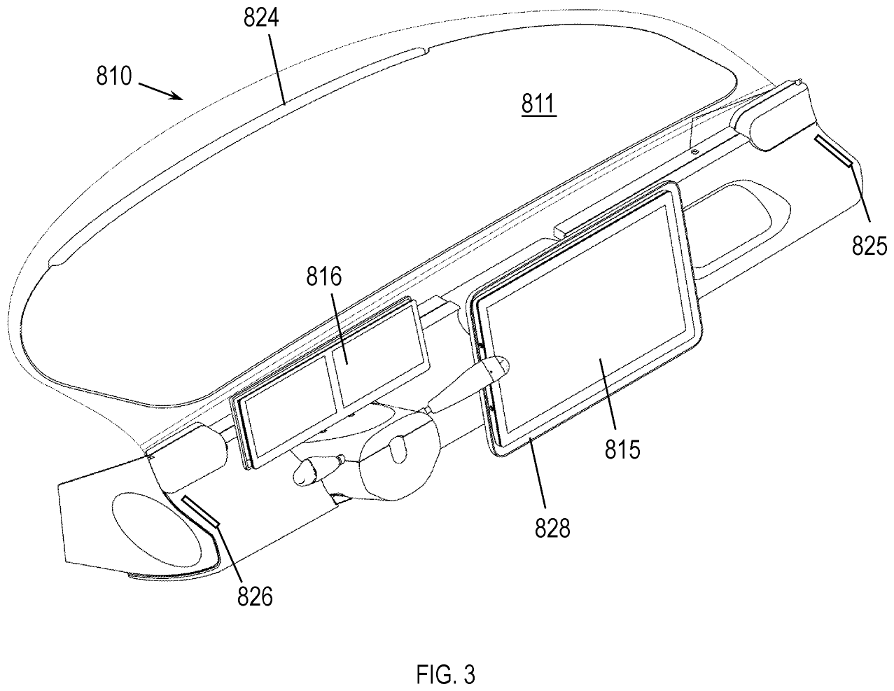

Referring to FIGS. 1-13, 14A-14B, and 15A-15B, an HVAC system generally designated as reference element 600 is useful for heating, cooling, and ventilating a vehicle cabin 800. The HVAC system 600 comprises an airside system 820, which may include a multidirectional vent assembly 828 centrally disposed on and/or within a dashboard 810 as shown in FIG. 3. Multidirectional vent assembly 828 may be formed integrally with a user interface 815 mounted to dashboard 810 and may be configured to provide airflow 839 within cabin 800, in a manner that maintains the effectiveness of conventional vents in terms of aerodynamic control and stability. Multidirectional vent assembly 828 also provides an aesthetically appealing design that conforms to the dashboard 810 and provides reduced visibility of vents 833, and other traditionally visible components, like vanes 836 and flaps. As should be appreciated, multidirectional vent assembly 828 is described in the context of conforming to a user interface 815 but is non-limiting in that concepts pertaining to airside system 820 described herein may be applied to any application, and may be formed on, in, or proximate to any vehicle component, whether that be on a dashboard 810 or otherwise.

FIG. 1 illustrates HVAC system 600 as a schematic wherein each type of component may contain one or more of the same component, but preferably has the quantity shown, i.e., one or multiple. An HVAC system 600 as represented in FIG. 1 is useful for illustrating the environment in which the present invention pertains and is provided for context of its functional components. The HVAC system 600 comprise plant and airside system 605 and 820, respectively, as well as controls 805 thereof and a user interface 815. The phrase “user interface” in this context may refer to any type of surface capable of receiving a command from a user within a vehicle, including but not limited to a touchscreen, a touchscreen having one or more knobs and/or buttons protruding therefrom, and a digital display with or without control knobs and/or buttons. In some embodiments, the HVAC system 600 may thermally couple to the touchscreen to facilitate temperature control of the screen. In other embodiments, the HVAC system 600 may be thermally decoupled from the touchscreen so that the screen is not affected by the temperature(s) of the airflow. In yet other embodiments, the HVAC system 600 may be actively or passively control to thermally couple to the touchscreen, or thermally decouple from the touchscreen, as desired.

A plant 605 typically defines where energy is transferred, or transformed, from one form to another, and it may include a chiller 610 that defines a source of cooling, one or more heating elements 620 which define a source of heating. A plant 605 may also include various thermal exchangers, such as a heat exchanger 630 to reject heat to the ambient, and cooling coils 822 to condition an airflow 839. The heating element in this context may be an electric heating coil, but other types of heating elements 620 are common as well.

Airside components 820 are typically distinguishable from other system components in that they “see” or touch an airflow 830. Therefore, coils for cooling 822 or heating 620 essentially span both categories, air is pushed or pulled over them passively or actively, such as by a fan 821 or other device, and then forced through a series of airflow channels 827. The airflow channels 827 may include ribs 834 acting as stationary structural and/or directional features, and also moveable features such as dampers 823, vanes 835, blades 836 and slots 837. A damper 823 is characterized in that it opens or closes a single airflow channel 827, or modulates flow therethrough, and is typically motorized and controlled via a control subsystem 806. One or more vanes 835, blades 836 or slots 837 adjustably guide airflow through the outlet or vent 833, and may be motorized, manually adjustable, or stationary. Airside components 820 may be formed in a manner consistent with multidirectional vent assembly 828 and will be elaborated upon below. In any of the embodiments contemplated herein, the general structure of airside system 820 may dictate or influence the characteristics of the airflow.

The user interface 815 can be formed as a display having a touchscreen designed to give the user control over many aspects of the airside and plant systems 605, 820 of the vehicle. For example, the user interface 815 can be used to control temperature, humidity, the direction and speed of airflow 839 coming out of the vents 833, whether that airflow is being cycled throughout the vehicle or combinedly mixed with ventilation (outdoor) air, and also which vents 833 are being used via control of the aforementioned dampers 823. Via the HVAC control system 805, the user interface 815 may provide airflow and temperature control within discrete locations of the cabin 800, such as control to individual passengers or the driver, and also to cabin 800 locations, such as the floor, chest level, head level, ceiling, or windows via selection of appropriate airflow channels 827 and/or directional control of vanes 835.

HVAC control system 805, and control subsystems 806 thereof, can include controllers, processors, memory, and storage. The HVAC control system 805 can send instructions to the airside and plant systems 605, 820. The HVAC control system 805 can also receive feedback from cabin 800 conditions, via various sensors for temperature, humidity, and/or cameras, to further specify desirable conditions therein. Furthermore, the HVAC control system 805 can send information to the display of the user interface 815 to display setpoints and the like to be viewed by the user. Additionally, all manner of sensors may be deployed throughout locations in the system 600, such as thermistors and the like, to form the basis of controlling intelligently the airflow characteristics of the airside system 820 and/or plant system 605.

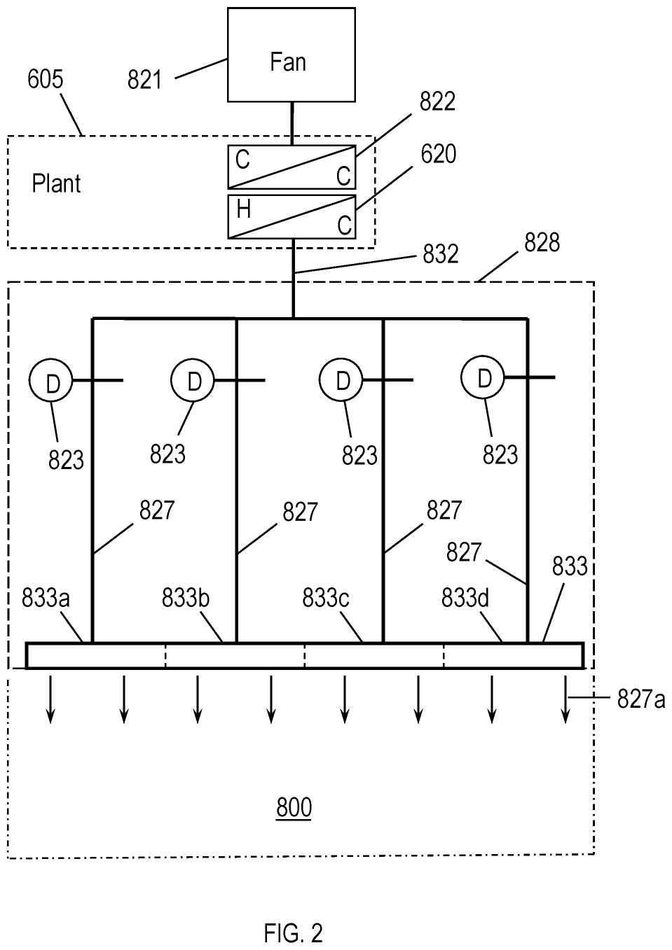

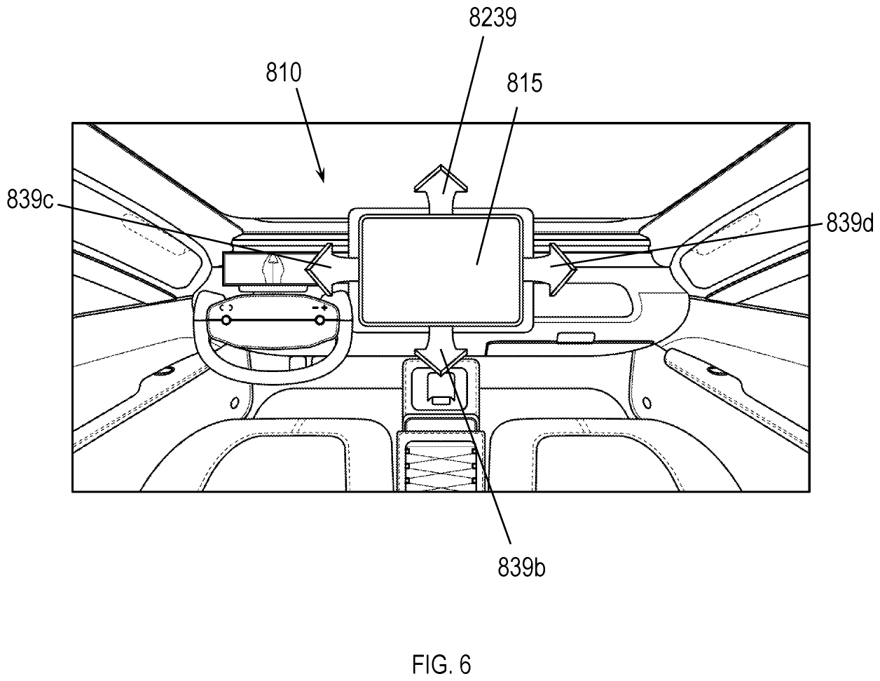

The line diagram of FIG. 2 provides an exemplary configuration of a multidirectional vent assembly 828, and associated airside components coupled thereto, wherein the lines depict airflow channels 827 defined by the HVAC system 600 of the invention. One or more fans 821 draw air from the cabin 800, the ambient, or both. The fan 821 typically pushes air, but may alternatively draw air through coils, such as cooling coil 822 or heating element 620, which derive their energy source from plant 605. Airflow 839 is thereby conditioned and passes to multidirectional vent assembly 828 via an inlet 832. The multidirectional vent assembly 828 may further comprise one or more airflow channels 827, wherein each channel 827 corresponds to a desired characteristic of the cabin 800. One such desired characteristic is direction, which may be generally described as upward, downward, leftward-towards driver's side, rightward-towards passenger's side, outward-extending away from the dashboard 810 in the direct from front to rear of the vehicle, and/or inward-extending toward the dashboard 810 in the direction of the windshield from rear to front of the vehicle, or any combination thereof, as shown in FIG. 6 having representative directional arrows illustrating airflows 839.

Another desired characteristic is to provide the function of individual temperature and/or humidity control. Accordingly, the invention has a dedicated inlet 832 corresponding to each of the plurality of airflow channels 827, and wherein a plurality of coils, including cooling coils 822 and/or heating coils 620, or a series of coil bypasses provide a system capable of producing a plurality of airflows 839, each having unique air conditions of temperature and/or humidity. A further desired characteristic is to provide a volumetric flow rate through each airflow channel 827 of the plurality of airflow channels 827. For example, the quantity of air pushed through an airflow channel 827 may be varied as compared to the quantity of air through another airflow channel. Dampers 823 may be employed as necessary to achieve the varying volumetric flow rate separately through each of the airflow channels 827.

In operation, any combination of the desired characteristics may be employed and, more generally, a plurality of airflow channels 827 provide a mechanism by which cabin conditions can be discretized. Additionally, FIG. 2 shows a common vent 833; alternatively, discrete vents may be used, corresponding to a vent 833a-833d for each airflow channel 827, or combined as desired. Consequently, airflow channels 827 may couple to linear slot vents (i.e., diffusers) that provide reduced visibility and an improved aesthetic for the vehicle user. Alternatively, airflow channels 827 may be coupled to any form of vent, and this description is to be construed as non-limiting in at least that respect.

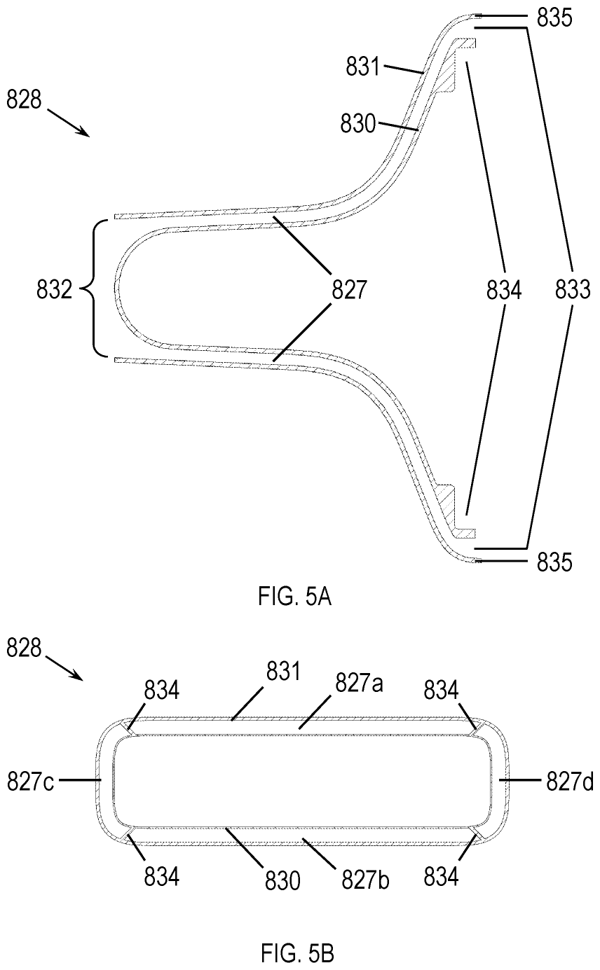

An embodiment of the multidirectional vent assembly 828 is shown in the context of a vehicle environment in FIGS. 3-6. Referring to FIG. 3, a multidirectional vent assembly 828 may be coupled to a user interface 815 such that airflow channels 827 are formed within, or form at least a portion of, the mount 835, which is visible in FIG. 5A. The multidirectional vent assembly 828 may also effectively couple the user interface 815 to the dashboard 810, forming an integral part thereof. Dashboard 810 may further comprise defrost vent 824, passenger's side window vent 825, and/or driver's side window vent 826. An instrument panel 816 may be disposed behind a steering wheel (not shown). In an alternative embodiment, concepts herein pertaining to the multidirectional vent assembly 828 may be applied to the instrument panel 816.

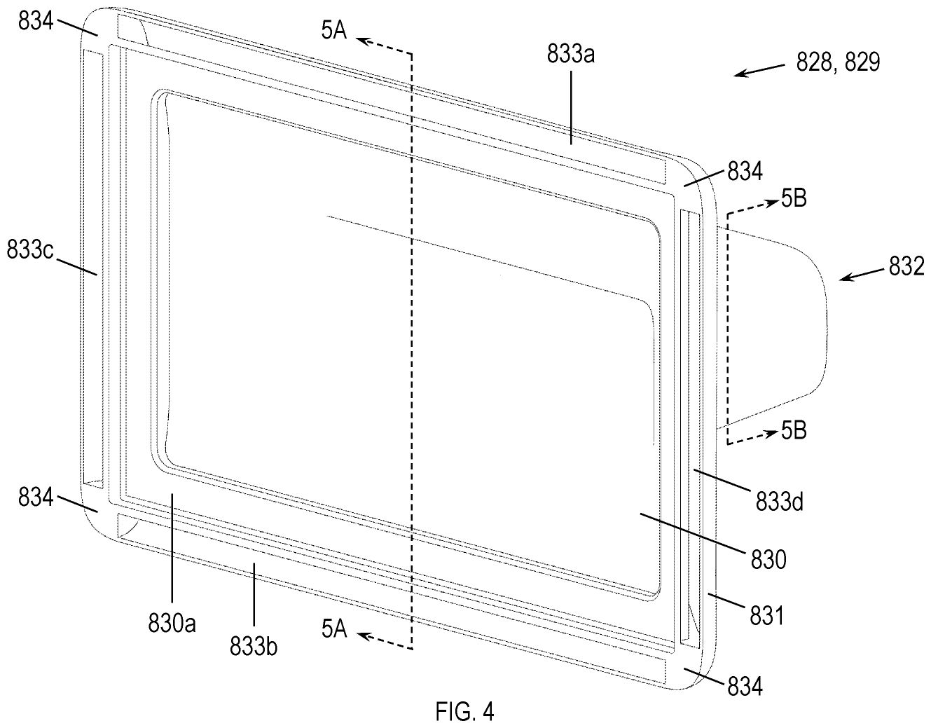

Referring now to FIG. 4, the multidirectional vent assembly 828 is shown without a display or the user interface 815 along with other components of the dashboard 810, so that characteristics of the assembly 828 may be more readily observed. Multidirectional vent assembly 828 may comprise a manifold 829 having an inner portion 830 and an outer portion 831 forming at least a portion of one or more airflow channels 827. The inner portion 830 may include a recess 830a configured to receive the user interface 815 within the multidirectional vent assembly 828 to fixedly position the user interface 815 in, on, or offset from the dashboard 810. Multidirectional vent assembly 828 may contain further components (not shown) to reposition the user interface 815, but generally speaking, the assembly may be considered fixed in its position relative to the dashboard 810. At one extent, an inlet 832 may be in fluid communication with one or more fans 821, and other upstream components, such as a cooling coil 822 and/or heating element 620 (not shown). At another extent, one or more vents 833a-833d may be in fluid communication with the cabin 800, as shown diagrammatically in FIG. 2, or as shown in an environmental view in FIG. 6 having a representative airflow distribution 839a-839d.

FIG. 5A illustrates the inner portion 830, forming the interior portion of one or more airflow channels 827, that comprises an interior cavity located behind the assembled user interface 815, which may house components including, but not limited to, electronic components like HVAC control system 805 and/or mechanical components like motorized components of one or more dampers 823. Also, inner portion 830 may include, specifically along the surface forming part of the inlet 832, a smooth profile-any shape that is conducive to forming and directing desirable airflow effects, such as a profile that promotes laminar flow as the airflow 839 enters inlet 832 and passes further though one or more airflow channels 827. Shown here, that part of inner portion 830 is U-shaped. Proximate the one or more vents 833 of the multidirectional vent assembly 828, the inner portion 830 may be configured with convective or conductive features that promote cooling of the user interface 815. Convective or conductive features (not shown) may be active or passive and may further include sensors to determine the need for user interface cooling in conjunction with HVAC control system 805. The inner portion 830 may be further described as having a generally tapered profile, extending between said inlet 832 and said one or more vents 833.

Similarly, the outer portion 831, may have a generally tapered profile complementary to that of inner portion 830, also extending from said inlet 832 to said one or more vents 833. Along the part of outer portion 831 that forms at least part of the inlet 832, outer portion 831 may be coupled to other HVAC system 600 components, such as one or more fans 821, or coils e.g., 822, 620. Conversely, the outer portion 831 may be coupled to a larger network of supply ductwork that serves other vents 833 of the airside system 820, like defrost vent 824, passenger's side window vent 825, driver's side window vent 826, or other vents or airside system 820 components. The multidirectional vent assembly 828 may alternatively be configured to position the user interface 815 at an offset distance from the dashboard 810.

The location of the one or more vents 833 may be defined, at least in part, by one or more vanes 835 disposed on outer portion 831. Importantly, the location of the vanes 835 may vary according to the desired airflow characteristics of the vents 833. The vanes 835 may extend slightly beyond the extent of the inner portion 830 substantially as shown with respect to a horizontal direction. The vanes 835 may alternatively terminate before the rightmost extent of inner portion 830, thereby outwardly angling the airflow 839. In another alternative, the vanes 835 may form a non-uniform profile surrounding inner portion 830, in that they may be wider in some areas, thinner in others, and closed in yet others. Such variations to the vent 833 are also non-limiting, and may be applied either horizontally or vertically, or both, to achieve the desired effect of directing airflow 830 and more generally to the purpose of forming a vent suitable for the application of providing passenger comfort. The formation of the vent 833 is integral to the pattern and formation of airflow 839 distributed to the cabin 800, and therefore, any dimensioning and positioning is contemplated as being within the scope of this disclosure. In one example, the opening dimension is 10 mm. Alternatively, the opening dimension may be greater or less than 10 mm, as desired.

Referring to FIG. 5B, the multidirectional vent assembly 828 may be configured as one or more airflow channels 827a-827d corresponding to vents 833a-833d, formed by ribs 834 which couple the inner portion 830 to the outer portion 831. In the example of FIG. 5B, four generally slot-shaped airflow channels 827a-827d are formed. In such a configuration, any one airflow channel 827 may be uni-directional. In an alternative embodiment, ribs 834 may be disposed at the center of each side of the substantially rectangular profile formed by inner and outer portions 830, 831, thereby achieving a substantially L-shaped airflow channel. In such a configuration, any one airflow channel 827 may be bi-directional. Although four airflow channels 827a-827d are shown, alternatively any number of airflow channels 827 may be utilized. For example, the manifold 829 may have one airflow channel 827 (i.e., no ribs 834) or eight airflow channels 827 to provide a more refined design approach. Furthermore, outlets 833 may be provided along only a portion of the perimeter defined by the user interface 815.

As shown in FIG. 6, representative directional airflows 839a-839d are provided. These are shown at discrete locations along one or more vents 833 of, e.g., FIG. 2. Airflows 839 may extend along the entirety of the perimeter formed by the user interface 815, rather than along a portion there. The arrangement of airflow distribution shown in FIG. 6 is generally for representative purposes to illustrate flow distribution as contemplated herein.

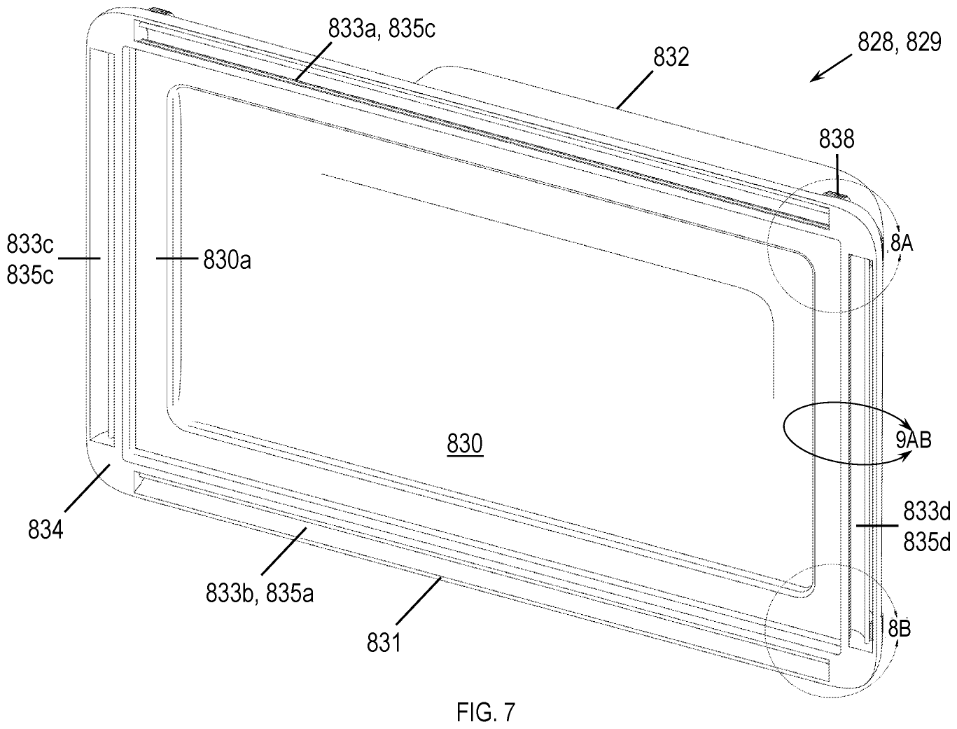

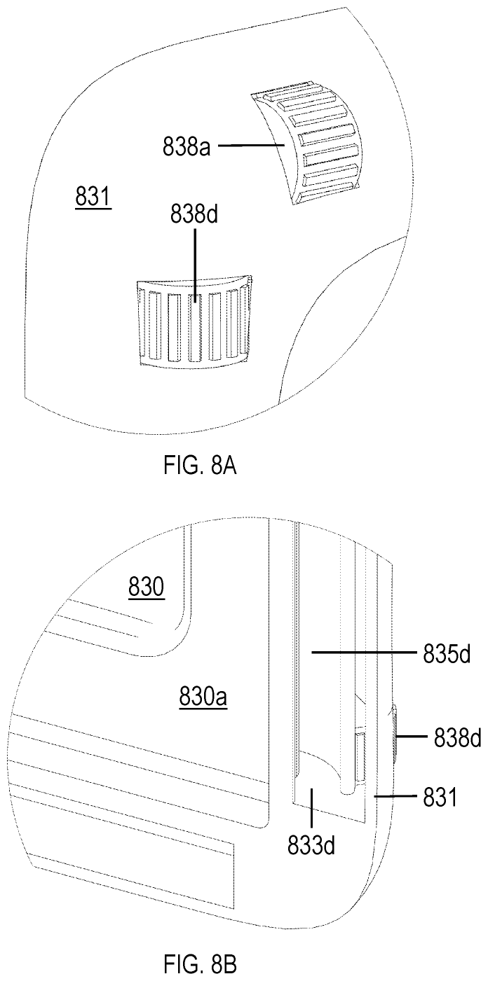

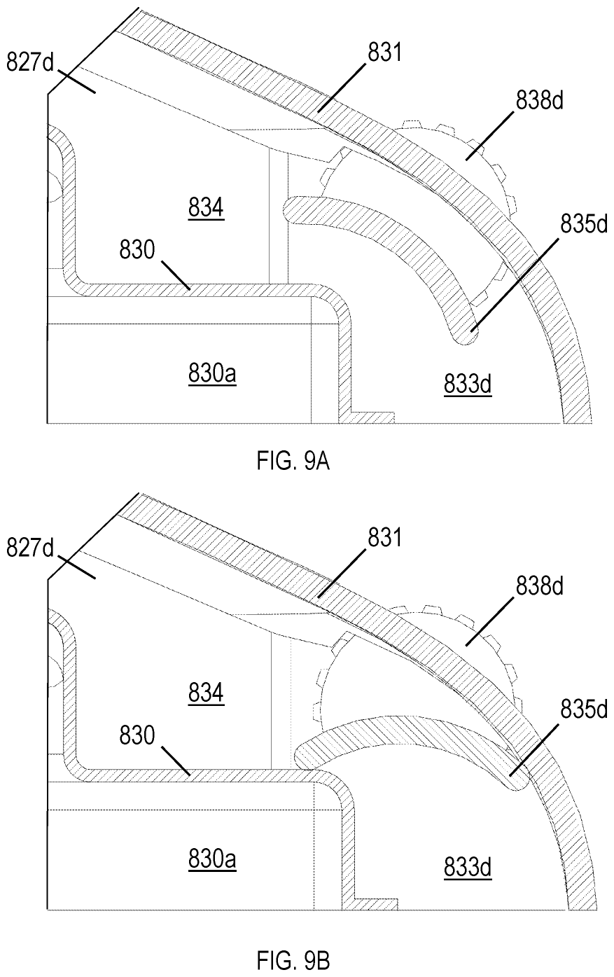

In an alternative embodiment, inner vanes 835a-835d may be employed to further direct airflow, as illustrated in FIGS. 7, 8A-8B, and 9A-9B. Referring to FIG. 7, a multidirectional vent assembly 828 may comprise a manifold 829 having an inner portion 830 and an outer portion 831. Inner portion 830 may comprise a recess 830a configured to receive a user interface 815 (not shown). Inner 830 and outer 832 portions may be coupled by one or more ribs 834 running from proximal an inlet 832 to an outlet 833 forming one or more airflow channels 827 corresponding to one or more vents 833. One or more vanes 835a-835d may be disposed in the one or more vents 833a-833d to further tailor the direction and volume of airflow 839. The vanes 835a-835d may be actuated manually, i.e., passively, by one or more thumbwheels 838 disposed thereon. Alternatively, vanes may be actuated automatically and/or actively, wherein, for example, one or more motors are configured to operably control the opening, closing, and/or repositioning of one or more vanes 835a-835d. FIG. 8A shows the expanded view corresponding to detail 8A of FIG. 7 from the inlet 832 perspective wherein the thumbwheels 838a and 838d, corresponding to vents 833a and 833d, may be seen more clearly. Thumbwheel actuators 838 may be disposed at each end of each vane 835 for ease of access. FIG. 8B shows the expanded view corresponding to detail 8B of FIG. 7 wherein a portion of a vane 835d may be viewed within the vent 833d. The recessed position of the vane 835d allows it to be partially concealed, while the thumbwheel is generally obscured by the front of the manifold 829, thereby retaining a clean overall appearance for the multidirectional vent assembly 828. FIGS. 9A and 9B illustrate a top-down section view taken at detail 9AB of FIG. 7. In FIG. 9A the vane 835d is in a middle open position within the airflow channel 827d formed between inner 830 and outer 831 portions. The vane 835d may be rotated clockwise (CW) or counterclockwise (CCW) using the thumbwheel 838d to direct the flow more toward the center of, or further away from, the assembly 828, respectively. The vane 835d may be rotated fully CCW to close the vent 833d, as shown in FIG. 9B. In this way, individual vents 833 may be opened, directed or closed, according to passenger comfort.

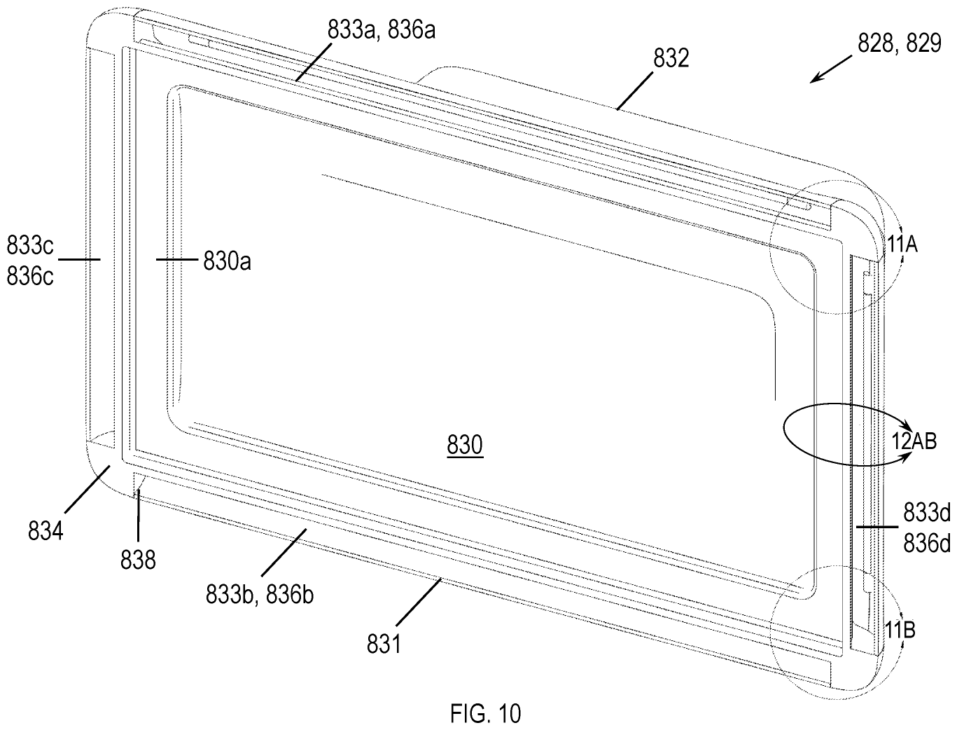

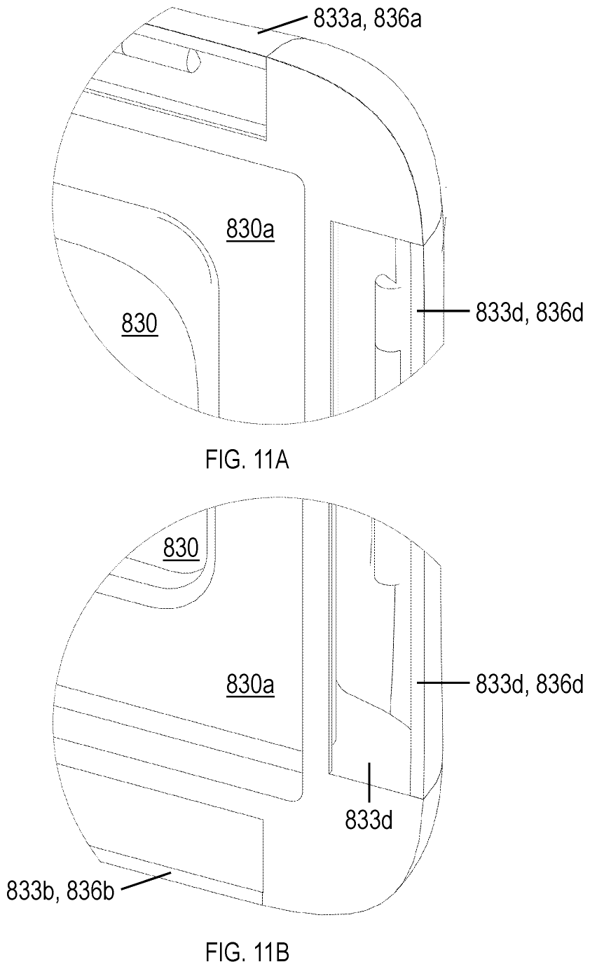

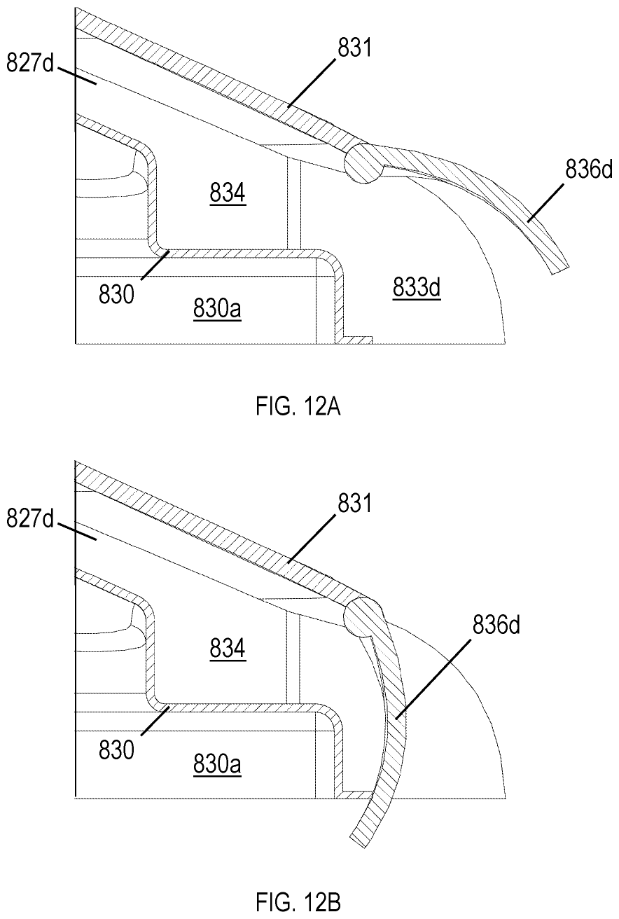

In an alternative embodiment, inner blades 836a-836d may be employed to further direct airflow, as illustrated in FIGS. 10, 11A-11B, and 12A-12B. Referring to FIG. 10 a multidirectional vent assembly 828 may comprise a manifold 829 having an inner portion 830 and an outer portion 831. Inner portion 830 may comprise a recess 830a configured to receive a user interface 815 (not shown). Inner 830 and outer 832 portions may be coupled by one or more ribs 834 running from proximal an inlet 832 to an outlet 833 forming one or more airflow channels 827 corresponding to one or more vents 833. One or more vanes blades 836a-836d may be disposed at the edge of one or more vents 833a-833d to further tailor the direction and volume of airflow 839. The blades 836a-836d may be rotatably coupled to the manifold 829 and may be actuated manually or automatically. FIG. 11A shows the expanded view corresponding to detail 11A of FIG. 10 from the outlet 832 perspective wherein the blade 836d, corresponding to vent 833d, may be seen more clearly. FIG. 11B shows the expanded view corresponding to detail 11B of FIG. 10 wherein a portion of a blade 836d may be viewed in a neutral position with respect to the vent 833d. In this position the blade 836d forms a continuous, arcuate shape with the manifold 829, thereby retaining a clean overall appearance for the multidirectional vent assembly 828. FIGS. 12A and 12B illustrate a top-down section view taken at detail 12AB of FIG. 10. In FIG. 12A the blade 836d is in a fully open position with respect to the airflow channel 827d formed between inner 830 and outer 831 portions. The blade 836d may be rotated CCW or CW to direct the flow more toward the center of, or further away from, the assembly 828, respectively. The blade 836d may be rotated fully CW to close the vent 833d, as shown in FIG. 12B. In this way, individual vents 833 may be opened, directed or closed, according to passenger comfort.

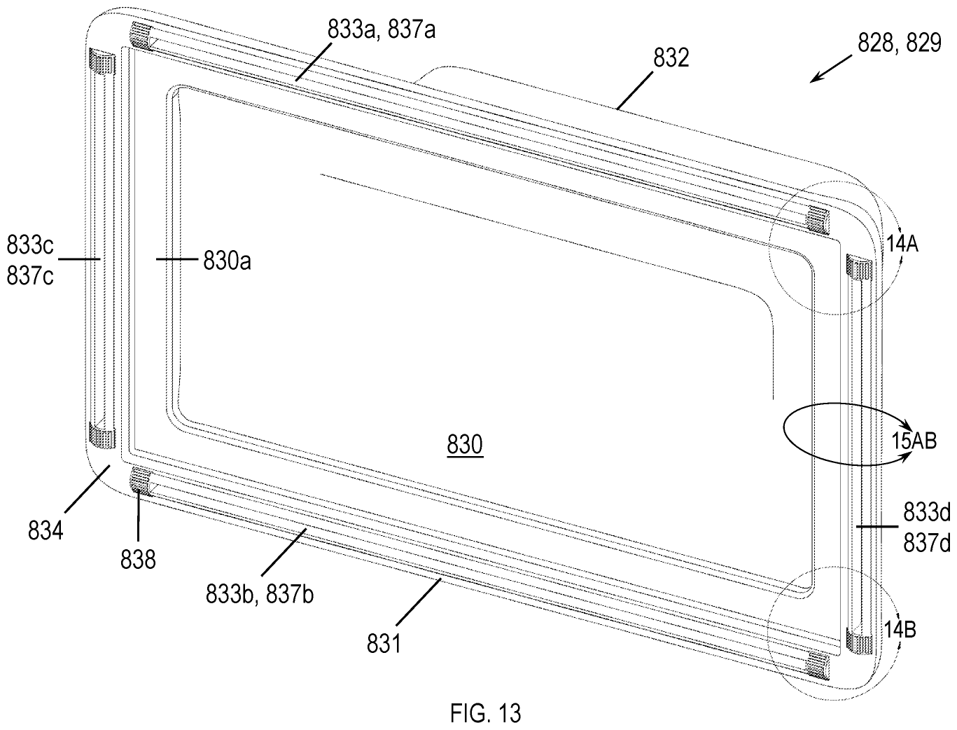

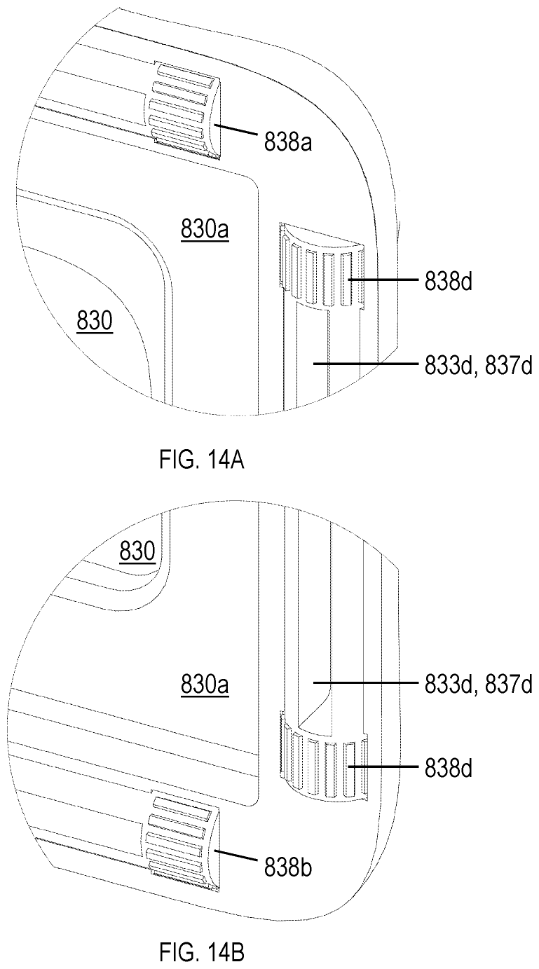

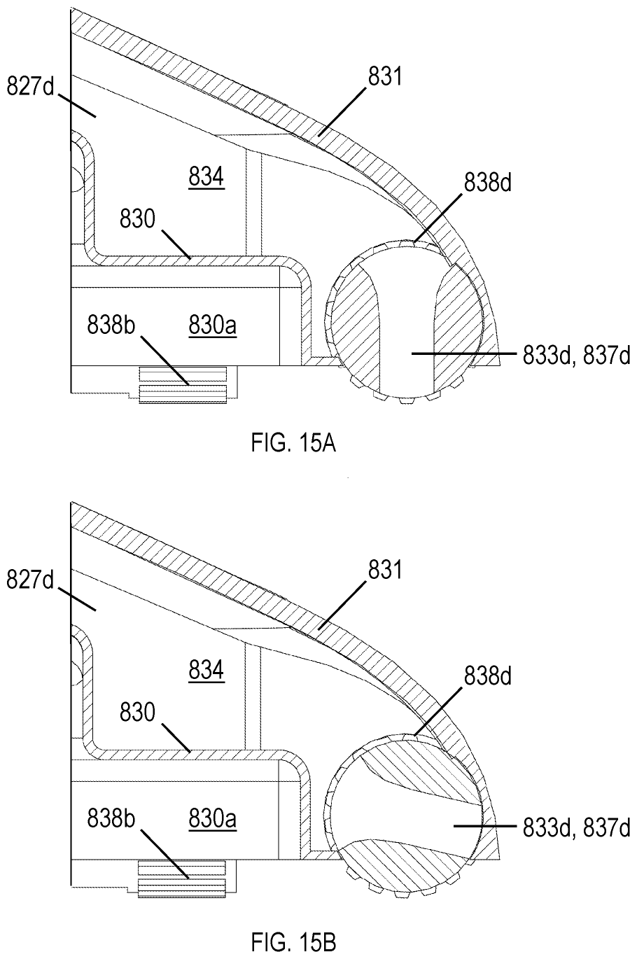

In an alternative embodiment, rotatable slots 837a-837d may be employed to further direct airflow, as illustrated in FIGS. 13, 14A-14B, and 15A-15B. Referring to FIG. 13 a multidirectional vent assembly 828 may comprise a manifold 829 having an inner portion 830 and an outer portion 831. Inner portion 830 may comprise a recess 830a configured to receive a user interface 815 (not shown). Inner 830 and outer 832 portions may be coupled by one or more ribs 834 running from proximal an inlet 832 to an outlet 833 forming one or more airflow channels 827 corresponding to one or more vents 833. One or more rotatable slots 837a-837d may be disposed in the one or more vents 833a-833d to further tailor the direction and volume of airflow 839. The slots 837a-837d may be actuated manually by one or more thumbwheels 838 disposed thereon. Alternatively, vanes may be actuated automatically. FIG. 14A shows the expanded view corresponding to detail 14A of FIG. 13 wherein the thumbwheels 838a and 838d, corresponding to vents 833a and 833d, may be seen more clearly. Thumbwheel actuators 838 may be disposed at each end of each slot 837 for ease of access. FIG. 14B shows the expanded view corresponding to detail 14B of FIG. 13 wherein the thumbwheels 838b and 838d, corresponding to vents 833b and 833d, may be seen more clearly. The shallow protrusion of the slots 837a-837d allows the multidirectional vent assembly 828 to retain a clean overall appearance. FIGS. 15A and 15B illustrate a top-down section view taken at detail 15AB of FIG. 13. In FIG. 15A the slot 837d is in a middle open position within the airflow channel 827d formed between inner 830 and outer 831 portions. The slot 837d may be rotated clockwise CW or CCW using the thumbwheel 838d to direct the flow more toward the center of, or further away from, the assembly 828, respectively. The vane 835d may be rotated fully CCW to close the vent 833d, as shown in FIG. 15B. In this way, individual vents 833 may be opened, directed or closed, according to passenger comfort.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A multidirectional vent for a vehicle heating, venting, and cooling system comprising:
an airside system including a multidirectional vent assembly comprising:
a manifold comprising:
an inner portion;
an outer portion;
one or more inlets;
one or more outlets disposed opposite the one or more inlets;
one or more ribs coupling the inner and outer portions disposed from proximal the one or more inlets to the one or more outlets and forming one or more airflow channels therebetween; and
a recess disposed at an outlet end configured to receive a user interface,
wherein the multidirectional vent assembly is disposed in the vehicle cabin and integrally formed with the user interface.

2. The multidirectional vent of claim 1 comprising one or more outlets disposed around the perimeter of the user interface.

3. The multidirectional vent of claim 1 wherein the outlets are selected from the group consisting of: actively adjustable, passively adjustable, and stationary.

4. The multidirectional vent of claim 1 comprising a plurality of outlets wherein the rate of air flow through each outlet is individually adjustable.

5. The multidirectional vent of claim 1 wherein the airflow volume and/or direction through the one or more outlets is adjusted by one or more elements selected from the group consisting of: vanes, blades, and slots.

6. The multidirectional vent of claim 1 comprising one or more outlets wherein the direction of air flow through each outlet is characterized as unidirectional or bidirectional.

7. The multidirectional vent of claim 1 centrally disposed on a dashboard and/or an instrument panel.

8. The multidirectional vent of claim 1 configured to position the user interface at an offset distance from the dashboard.

9. The multidirectional vent of claim 1 wherein the outlets are hidden behind the user interface.
